(19) United States
(12) Patent Application Publication
(10) Pub. No.: US 2026/0267481 A1
(43) Pub. Date: Sep. 10, 2026

(54) INTERACTION METHOD AND APPARATUSES, COMPUTER-READABLE STORAGE MEDIUM AND COMPUTER PROGRAM PRODUCT

(71) Applicant: Beijing Zitiao Network Technology Co., Ltd., Beijing (CN)

(72) Inventor: Zhanpeng SUN, Beijing (CN)

(21) Appl. No.: 19/168,146

(22) PCT Filed: Jul. 29, 2024
(86) PCT No.: PCT/CN2024/108182

§ 371 Date: Sep. 23, 2025

(30) Foreign Application Priority Data
Nov. 27, 2023 (CN) 202311597162.3

(51) Int. Cl. G06F 3/0484; G06F 3/0482

(52) U.S. Cl. CPC G06F 3/0484; G06F 3/0482

(57) ABSTRACT

The present disclosure relates to an interaction method, interaction apparatuses, a computer-readable storage medium and a computer program product, and relates to the technical field of multimedia. The interaction method includes: receiving a first input from a user who controls a virtual character in interactive multimedia content; in response to a mismatch between the first input and an original plot of the interactive multimedia content, determining a first target character from one or more first-type characters based on the first input and the original plot of the interactive multimedia content, and generating a temporary scenario, wherein the first-type characters are non-user controlled virtual characters in the interactive multimedia content, and the temporary scenario is used to guide the user to provide a second input to trigger the original plot; generating first interaction information of the first target character with respect to the first input based on the first input, the original plot, and the temporary scenario; displaying the first interaction information of the first target character with respect to the first input.

### CROSS-REFERENCE TO RELATED APPLICATIONS

This application is based on and claims the benefit of priority of the Chinese patent application No. 202311597162.3 filed on Nov. 27, 2023, which is hereby incorporated by reference in its entirety into the present application.

### TECHNICAL FIELD

This disclosure relates to the field of multimedia technology, particularly to an interaction method, an apparatus, a computer-readable storage medium, and a computer program product.

### BACKGROUND

With the development of computer technology and multimedia technology, interactive multimedia content such as video games and interactive TV dramas are becoming increasingly popular among users. Interactive multimedia content typically advances the plot according to a predetermined script. For example, at nodes where user interaction is enabled, one or more pre-configured options are presented to the user. After receiving a user selection for an option, a plot corresponding to the selected option is triggered according to the rules set in the script.

### SUMMARY

This summary is provided for a concise introduction of the inventive concept of the present application, which will be described in detail in the Detailed Description below. This summary is not intended to identify critical features or essential features of the claimed technical solution, nor is it intended to be used to limit the scope of the claimed technical solution.

According to some embodiments disclosed herein, there is provided an interaction method, including: receiving a first input from a user, the user controlling a virtual character in interactive multimedia content; determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot; generating first interaction information of the first target character with respect to the first input based on the first input, the original plot, and the temporary plot; and displaying the first interaction information of the first target character with respect to the first input.

According to some embodiments of this disclosure, there is provided an interaction apparatus, including: an input device configured for receiving a first input from a user, the user controlling a virtual character in interactive multimedia content; one or more processors configured for: determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot; and generating first interaction information of the first target character with respect to the first input based on the first input, the original plot, and the temporary plot; and a display configured for displaying the first interaction information of the first target character with respect to the first input.

According to some embodiments of this disclosure, there is provided an interaction apparatus, including: a receiving module configured for receiving a first input from a user, the user controlling a virtual character in interactive multimedia content; a first generation module configured for determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot; a second generation module configured for generating first interaction information of the first target character with respect to the first input based on the first input, the original plot, and the temporary plot; and a first display module configured for displaying the first interaction information of the first target character with respect to the first input.

According to some embodiments of this disclosure, there is provided an interaction apparatus, comprising: a memory; and a processor coupled to the memory, the processor being configured to perform the interaction method provided by any embodiment of this disclosure based on instructions stored in the memory.

According to some embodiments of this disclosure, there is provided a computer-readable storage medium stored thereon a computer program that, when executed by a processor, performs the interaction method provided by any embodiment of this disclosure.

According to some embodiments of this disclosure, there is provided a computer program product that, when running on a computer, enables the computer to implement the interaction method provided by any embodiment of this disclosure.

According to some embodiments of the present disclosure, there is provided a computer program, including: instructions that, when executed by a processor, cause the processor to perform the interaction method provided by any embodiment of this disclosure.

Other features, aspects and advantages of the present disclosure will become apparent from the following detailed description of exemplary embodiments of the present disclosure with reference to the accompanying drawings.

### BRIEF DESCRIPTION OF THE DRAWINGS

Below, preferred embodiments of this disclosure will be described with reference to the drawings. The accompanying drawings described herein are intended to provide a further understanding of the present disclosure, and together with the specific description of the drawings below, are included in and constitute a part of the present specification for illustration of the present disclosure. It should be understood that the drawings described below merely involve some embodiments of the present disclosure, and are not limitations of the present disclosure. In the drawings:

FIG. 1 shows a flowchart of an interaction method according to some embodiments of the present disclosure;

FIG. 2 shows a flowchart of a method for generating a temporary plot according to some embodiments of the present disclosure;

FIG. 3 shows a flowchart of a method for generating first interaction information according to some embodiments of the present disclosure;

FIG. 4 shows a flowchart of an interaction method according to other embodiments of the present disclosure;

FIG. 5 shows a flowchart of an interaction method according to further embodiments of the present disclosure;

FIG. 6 shows a flowchart of an interaction method according to still other embodiments of the present disclosure;

FIG. 7A shows a schematic diagram of interaction among a plurality of characters according to some embodiments of the present disclosure;

FIG. 7B shows a schematic diagram of interaction among a plurality of characters according to other embodiments of the present disclosure;

FIGS. 8A to 8C show interface diagrams of interactive multimedia content according to some embodiments of the present disclosure;

FIG. 9 shows a schematic structure diagram of an interaction apparatus according to some embodiments of the present disclosure;

FIG. 10 shows a schematic structure diagram of an interaction apparatus according to other embodiments of the present disclosure;

FIG. 11 shows a block diagram of an electronic device according to some embodiments of the present disclosure;

FIG. 12 shows a schematic structure diagram of a computer system that can be adopted according to some embodiments of the present disclosure.

It should be understood that, for ease of description, the dimensions of the various parts shown in the drawings are not drawn to actual proportions. The same or similar reference numerals are used in each FIG. to indicate the same or similar components. Therefore, once an item is defined in a drawing, there is no need for further discussion in other accompanying drawings.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The description of the embodiments is merely illustrative, and in no way serves as any limitation on the present disclosure and its application or use. It should be understood that the present disclosure can be implemented in various forms and should not be construed as limited to the embodiments set forth herein.

It should be understood that the various steps described in the methods of the embodiments of the present disclosure may be executed in a different order, and/or executed in parallel. In addition, the methods may include additional steps and/or some of the illustrated steps may be omitted. The scope of this disclosure is not limited in this regard. Unless specifically stated otherwise, relative arrangement and values of components and steps, numerical expressions and values set forth in these embodiments are to be construed as merely illustrative, not limiting the scope of the present disclosure.

The term “including” and its variations used in this disclosure refer to an open-ended term that includes at least the following elements/features, but does not exclude other elements/features, i.e. “including but not limited to”. In addition, the term “containing” and its variations used in this disclosure refer to an open-ended term that includes at least the following elements/features, but does not exclude other elements/features, i.e., “containing but not limited to”. Therefore, the terms “including” and “containing” are synonymous. The term “based on” means “based at least in part on”.

“One embodiment”, “some embodiments” or “embodiments” used throughout the specification mean that specific features, structures or characteristics described in connection with the embodiments are included in at least one embodiment of the present invention. For example, the term “one embodiment” means “at least one embodiment”; the term “another embodiment” means “at least one additional embodiment”; the term “some embodiments” means “at least some embodiments”. In addition, occurrences of the phrases “in one embodiment,” “in some embodiments,” or “in embodiments” throughout this specification do not necessarily refer to the same embodiment, but may refer to the same embodiment.

It should be noted that the concepts of “first” and “second” mentioned in the present disclosure are only used to distinguish different devices, modules or units, and are not used to limit the order of functions performed by these devices, modules or units, or interdependence therebetween. Unless otherwise specified, terms such as “first” and “second” are not intended to imply that objects described in this way must be in any particular order in time, space, rank, or otherwise.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

The following will provide a detailed explanation of the embodiments disclosed herein with reference to the accompanying drawings, but the present disclosure is not limited to these specific embodiments. The following specific embodiments can be combined with each other, and the same or similar concepts or processes may not be repeated in some embodiments. In addition, in one or more embodiments, specific features, structures or characteristics may be combined in any suitable manner, as will be apparent to those skilled in the art from this disclosure.

After some interactive multimedia content has been generated, the interaction information that players can enter is also determined accordingly. For example, as the plot of interactive multimedia content progresses to certain nodes, users can be presented with one or more preset options for selection. After receiving a user selection for an option, a plot corresponding to the selected option is triggered according to the rules set in the script. However, as the interactive multimedia content is pre-scripted according to the predetermined narrative, it does not support users to input content beyond these options to progress the story. As a result, users have relatively low degrees of freedom and participation in the games.

In addition, there is some interactive multimedia content that can support arbitrary user input and make the story completely follow the user's input content. However, if too much freedom is given to the user, the progression of the plot can become very unreasonable, and the user experience can be severely degraded.

In view of this, a technical problem to be solved by the present disclosure is: how to automatically and sensibly promote interactive multimedia content while giving users a certain degree of freedom to improve the user experience.

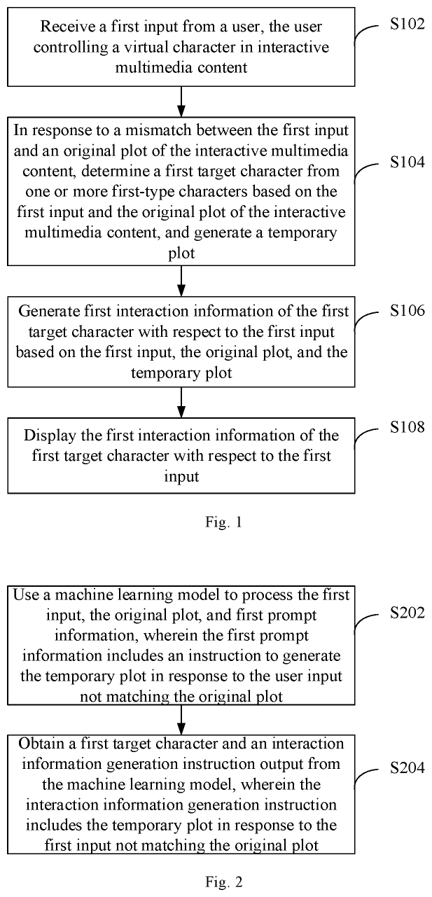

FIG. 1 shows a flowchart of an interaction method according to some embodiments of the present disclosure. As shown in FIG. 1, the interaction method of this embodiment includes steps 102-108.

In step 102, a first input is received from a user, the user controlling a virtual character in interactive multimedia content.

The user in this embodiment refers to the object that interacts with the interactive multimedia content. For example, the user may be a player, viewer, or consumer of the interactive multimedia content. The interactive multimedia content includes a game, an interactive film, or an interactive story, etc.

The first input of the user is, for example, the result of selection from a plurality of options provided by the interactive multimedia content, or information freely entered by the user. For example, if the interactive multimedia content provides multiple options, and the user does not want to select any of the options, he/she can still freely enter the content desired through a displayed input control. Alternatively, the interactive multimedia content may not provide any options, but instead display input controls at the nodes where the user needs to interact, allowing the user to freely enter the desired content. The information that the user freely enters is, for example, natural language text. In the case where the interactive multimedia content provides some options, the natural language text may be completely different from the content of all the options, or identical to the content of one option, or have the same meaning as the content of one option but expressed differently.

In some embodiments, after receiving the first input from the user, the first input can be “performed” by a virtual character controlled by the user. For example, if the first input represent a dialogue, the virtual character controlled by the user can be instructed to speak the content, and the speaking process can be represented by at least one of playing the spoken content or displaying the spoken text. If the first input is an action, the virtual character controlled by the user can be instructed to perform the action. The action can be represented by displaying a textual description of the action, or by displaying an animation of the virtual character performing the action, or a combination thereof. Alternatively, instead of the user-controlled virtual character acting on the first input, the corresponding subsequent plot can be displayed directly on the basis of the first input.

In step 104, in response to a mismatch between the first input and an original plot of the interactive multimedia content, a first target character is determined from one or more first-type characters based on the first input and the original plot of the interactive multimedia content, and a temporary plot is generated, wherein the first-type characters are non-user controlled virtual characters in the interactive multimedia content, and the temporary plot is for guiding the user to provide a second input to trigger the original plot.

The original plot refers to the plot of the interactive multimedia content, which is fixed after the creation of the interactive multimedia content. For the same interactive multimedia content, the original plot remains consistent regardless of which user consumes it. However, due to the differences in input from different users, there may be differences in the actual content displayed and the actual plot progressed during the consumption of interactive multimedia content by different users. That is, the original plot is similar to a “script”, and is used to determine the backbone of the interactive multimedia content. However, some specific content of interactive multimedia content can be personalized and generated in real time based on user input, that is, intelligent secondary creation can be performed by synthesizing the original plot and user input.

The interactive multimedia content may include a plurality of chapters, and the original plot may correspond to one or all of the plurality of chapters of the interactive multimedia content.

If the first input is the result of selecting from options provided by the interactive multimedia content, the first input matches the original plot of the interactive multimedia content. That is, the original plot has pre-defined follow-up plots or multiple branching plots that need to be further developed, and the options provided also correspond to the plots. Therefore, in this case, the first input can match the original plot.

In the case where the first input is freely entered by the user, in some embodiments, if the first input matches a triggering condition in the original plot (used to trigger a plot after the current plot), the first input can be considered to match the original plot of the interactive multimedia content; if the first input does not match any triggering conditions in the original plot, it can be considered that the first input does not match the original plot of the interactive multimedia content. For example, if the content of the first input is exactly the same as the content of an option provided by the interactive multimedia content, or if the content of the first input has the same meaning as an option but with a different expression, it can be considered that the first input matches the original plot of the interactive multimedia content; if the first input is completely different from the content of all options, it can be considered that the original plot of the interactive multimedia content does not match the first input.

In response to the first input matching the original plot of the interactive multimedia content, a subsequent plot in the original plot corresponding to the first input can be triggered. In response to the first input not matching the original plot of the interactive multimedia content, a temporary plot will be generated. This temporary plot is a plot that is not present in the original plot, i.e. a plot that is automatically generated based on the user's personalized input. The temporary plot is a description of the content that is about to be displayed in interactive multimedia, which can be a general overview.

During a generating process of the temporary plot, it is necessary to reference both the first input and the original plot. This ensures that the temporary plot can balance the user's input with the original plot, that is, respond to the user's free-form input while remaining coherent within the framework of the original plot, thereby improving its logical consistency. In addition, this plot can guide the user to trigger the original plot, i.e., guide the user to provide a second input to trigger the original plot on the next input.

For example, if the player-controlled character is at a fork in a maze, the user must decide whether to take path A to the left or path B to the right, and there are corresponding follow-up plot in the original plot for each path choice. If the user chooses none of these options and uses the first input to indicate a step back, a temporary plot can be generated to encourage the user to make a choice. For example, the temporary plot could be a warning that stepping back is dangerous. As another example, the temporary plot might be that after the user-controlled character has stepped back for a while, the road behind the character collapses, making it impossible to continue stepping back. In another example, the temporary plot might be that after the user-controlled character has stepped back for a while, a new path is discovered that leads to path A, so that when the user's second input indicates going down that path, the original plot can be connected.

The temporary plot requires an appropriate virtual character as a carrier, i.e. a non-user-controlled virtual character to interact with the user-controlled virtual character. Therefore, in addition to determining the temporary plot, a first target character can also be determined. Therefore, the temporary plot is the content that the first target character wants to convey. For example, if the temporary plot conveys the need to be cautious, the first target character could be a character setting to be cautious.

In some embodiments, the temporary plot can be determined first and the first target character can be determined based on the temporary plot. Alternatively, the first target character can be determined before the temporary plot is determined. In addition, both the first target character and the temporary plot can be determined simultaneously.

In step 106, first interaction information of the first target character with respect to the first input is generated based on the first input, the original plot, and the temporary plot.

The first interaction information is used to respond to the first input and represents visual information corresponding to the temporary plot. The first interaction information may include, for example, the dialogue text of the first target character or options for the user to choose from. In addition, it can also include one or more of actions or expressions. For example, if the temporary plot says that stepping back is very dangerous, the first interaction information might be the first target character saying, “It's too dangerous behind, let's move forward.” As another example, if the temporary plot is that after the user-controlled character has stepped back for a while, the road behind the character collapses, making it impossible to continue stepping back, the first interaction information might be, in the scene with a collapsed road behind, the first target character saying “We can't go back now-our only way is forward!”, while presenting two options: Move left-forward and Move right-forward.

In step S108, the first interaction information of the first target character with respect to the first input is displayed. It can be displayed in the form of a text, a facial expression or an action of the first target character, etc.

For example, any type of first interaction information can be described by text if required. As for the spoken content text, expression description text and action description text of the first target character, different types of text can be displayed in different styles or positions. For example, the descriptive text of actions and expressions can be placed in parentheses to distinguish it from spoken content text.

For an expression or an action, the first target character can be instructed to perform the expression or action in order to make the temporary plot more vivid and concrete. This method requires the generation of appropriate multimedia resources, such as an animation of the first target character. The use of descriptive text can reduce the amount of data required to generate multimedia resources.

The above embodiment allows the user to provide a first input, which does not match the original plot, while viewing the interactive multimedia content. In addition, a temporary plot can be generated for the first input to guide the user back to the original plot while responding to the user's first input. Therefore, the embodiment of the present disclosure not only supports a certain degree of freedom for the user, but also enables the interactive multimedia content to advance the plot in a sensible manner and enhance the user experience.

Some embodiments of this disclosure may rely on artificial intelligence (AI) to generate the temporary plot or first interaction information. For example, machine learning models can be utilized to implement the generation process. The machine learning models used in the embodiment of this disclosure are, for example, generative models. Generative models are used to output target content based on input information. The input information includes the processing basis of the generative model during the generation process, such as what information is referenced to perform the generation process, the requirements of the output target content, and so on. Generative models include models that generate based on text or images, and their output can be text, images or a combination of text and images. Of course, the input or output of generative models can also be data from other modalities, such as audio, video, or a combination of multiple types of data. Generative models may be single-modal models, such as the models that generate text based on text (referred to as “text2text-generation model”), or models that generate images based on images (referred to as “image2image generation model”); or generative models may also be cross-modal models, the input and output of which belong to different modalities, such as models that generate images based on text (referred to as “text2image generation models”); or the input and output of generative models may be data from multiple modalities. Machine learning models can be implemented based on neural network models, such as Foundation Models or Large Language Models (LLM).

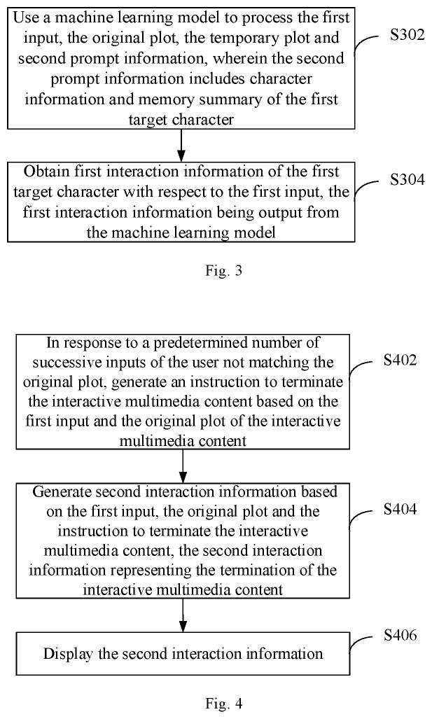

An embodiment of an AI-based generation method of this disclosure will be described below with reference to FIGS. 2 and 3, respectively.

FIG. 2 shows a flowchart of a method for generating a temporary plot according to some embodiments of the present disclosure. As shown in FIG. 2, the method for generating a temporary plot in this embodiment includes steps S202 to S204.

In step S202, a machine learning model is used to process the first input, the original plot, and first prompt information. The first prompt information includes an instruction to generate the temporary plot in response to the user input not matching the original plot.

The first prompt information is used to indicate the processing logic of the current task of the machine learning model, so that the machine learning model can understand the first input and the original plot according to the model (such as natural language understanding), and generate a temporary plot. The first prompt information is represented in a format that the machine learning model can parse. The first prompt information can be preset, such as content from a template. Templates may correspond to different tasks. For example, the first prompt information in step S202 may come from a template corresponding to temporary plot generation tasks.

In some embodiments, the first prompt information may be natural language text, for example, “Generate a scenario based on the user's input and the original plot. If the user's input deviates from the original plot, the generated temporary plot should be able to connect the current state with the original plot”.

Character information can also be referenced when generating the temporary plot. In some embodiments, the first prompt information further includes character information of the one or more first-type characters, and an instruction to select the first target character based on the character information. The character information includes at least one of a character setting, a dialogue style, or a behavioral guideline. The character setting includes a personality setting, a basic attribute setting (such as gender, age, etc.), and so on. Thus, based on the character information of the first-type characters, a suitable first target character can be selected to respond to the first input. In addition, the generated temporary plot can be more closely matched to the character playing the scenario. Based on this indication, the character information of the first target character may have a higher degree of match with the temporary plot, making it more reasonable for the first target character to host the temporary plot.

In step S204, a first target character and an interaction information generation instruction output from the machine learning model are obtained, wherein the interaction information generation instruction includes the temporary plot in response to the first input not matching the original plot.

The interaction information generation instruction is used to provide a basis for generating the first interaction information. Therefore, the subject used to generate the first interaction information can generate the first interaction information based on the temporary plot in the interaction information generation instruction. In addition to the temporary plot, the interaction information generation instruction also includes second prompt information. The second prompt, expressed in natural language, is “Generate a dialogue for the first target character based on the above temporary plot”, for example. According to the needs, the second prompt information may take other forms, which will not be repeated here.

Each first-type character can be configured with an interaction information generation module. The first interaction information can be sent to an interaction information generation module corresponding to the first target character to instruct it to generate the first interaction information. The interaction information generation modules configured for the first-type characters can also be implemented by machine learning models. The process of generating the first interaction information using a machine learning model will be illustrated below.

The above embodiment can automatically generate a temporary plot based on artificial intelligence, thereby efficiently generating the temporary plot according to a user input by leveraging the powerful computing capabilities and vast prior knowledge of artificial intelligence to quickly respond to the user input.

FIG. 3 shows a flowchart of a method for generating first interaction information according to some embodiments of the present disclosure. As shown in FIG. 3, the method for generating the first interaction information in this embodiment includes steps S302 to S304.

In step 302, a machine learning model is used to process the first input, the original plot, the temporary plot and second prompt information, wherein the second prompt information includes character information and memory summary of the first target character.

This machine learning model may be of the same type as, or different from, the machine learning model used in step S202. In the case of the same type, the machine learning model used in step S202 and the machine learning model used in step 1302 may even be the same model, but correspond to different agents. Thus, each agent has its own independent input, output and contextual information during processing, but all share the computational resources provided by the same machine learning model. If necessary, steps S202 and S302 can be performed by the same agent.

The second prompt information is used to indicate the processing logic of the current task of the machine learning model, so that the machine learning model can understand the first input, the original plot, and the temporary plot according to the model (such as natural language understanding), and generate the first interaction information. The second prompt information is represented in a format that the machine learning model can parse. The second prompt information may be preset, such as content from a template. For example, the second prompt information in step 302 can come from a template corresponding to interaction information generation tasks.

In some embodiments, the second prompt information may be natural language text. For example, “Generate a dialogue for the first target character based on the user input, original plot, and temporary plot”.

The memory summary of the first target character is a summary of events that the first target character has experienced in the interactive multimedia content. The interactive multimedia content may include one or more chapters. Assuming the story has progressed to chapter 3, if the first target character appears in chapters 1, 2, and 3, then the first target character's memory summary is a summary of the events that have already occurred in chapters 1 and 2; if the first target character only appears in chapters 1 and 3, then the memory summary of the first target character is a summary of the events that have already occurred in chapter 1. In addition, the memory summary can also include a summary of the events that have taken placed in the current chapter.

In step S304, first interaction information of the first target character with respect to the first input is obtained, the first interaction information being output from the machine learning model.

In some embodiments, the first input, the original plot, the temporary plot, and the second prompt information are input to an agent of the machine learning model corresponding to the first target character, and the first interaction information output from the agent is obtained. Therefore, when generating the first interaction information based on the first target character and the temporary plot, it is possible to avoid interference from other irrelevant information, thereby improving the accuracy of content generation. If the first interaction information is represented by text, a text generation model can be used; if the first interaction information is represented by an image, an image generation model can be used; if the first interaction information contains both text and images, the above two models can be used simultaneously, or a generative model that can output both text and images can be used.

The above embodiment can automatically generate the first interaction information based on artificial intelligence, thereby efficiently converting the temporary plot into interaction information based on the powerful computing capabilities and massive prior knowledge of artificial intelligence, so as to automatically provide a basis for the subsequent display content.

In the above embodiments, when the user's input deviates from the original plot, a temporary plot can be used to guide the user back. If the user insists on deviating from the plot several times consecutively, the original plot can be triggered directly by a temporary plot. For example, the original plot requires the user to explore the wreckage of a spaceship, but the user persistently enters first inputs to explore an alternative location. In this case, a temporary plot can be generated, indicating that the place the user wishes to explore has discovered a mysterious entrance. After entering the entrance, the user will discover that it leads directly to the spaceship wreckage.

Of course, if the user insists on deviating from the plot several times, it may be necessary to consider ending the game session right away. An interaction method provided by other embodiments of the present disclosure will be described below with reference to FIG. 4.

FIG. 4 shows a flowchart of an interaction method according to other embodiments of the present disclosure. As shown in FIG. 4, the interaction method of this embodiment includes steps S402 to S406.

In step S402, in response to a predetermined number of successive inputs of the user not matching the original plot, an instruction to terminate the interactive multimedia content is generated based on the first input and the original plot of the interactive multimedia content.

If a user's input consistently deviates from the original plot for a predetermined number of times, it indicates that the user's intent is not focused on advancing the plot. At this point the game can be terminated in time. However, an abrupt end can result in a poor user experience, so transition images can be created. An instruction to terminate the interactive multimedia content is used to indicate the ending of the plot of the interactive multimedia content, so that further interaction information can be generated based on this instruction. For example, the instruction might be “Generate a transition plot to go from user input to a screen of game failure”. In addition to natural language, this instruction can take other forms, which will not be explained here.

In some embodiments, the instruction can be generated using a machine learning model. For example, a machine learning model is used to process the first input and the original plot of the interactive multimedia content, and if the user's successive inputs do not match the original plot for a specified number of times, an instruction output from the machine learning model is obtained to generate a plot to terminate the interactive multimedia content. For the specific implementation of the machine learning model, reference can be made to the previous embodiments, which will not be repeated here.

In step S404, second interaction information is generated based on the first input, the original plot and the instruction to terminate the interactive multimedia content, the second interaction information representing the termination of the interactive multimedia content.

The second interaction information is used to respond to the first input and transition to a game failure interface. The second interaction information can be conveyed by a first-type character, or by a background image and a voice-over without involving any first-type character. The second interaction information may be visual information.

In step S406, the second interaction information is displayed.

For the way of displaying the second interaction information, reference can be made to the first interactive information, which will not be repeated here. At the end of the second interactive message, a game-over screen may be displayed.

For example, consider an example where the user is currently navigating a maze, the original plot requires the user to choose a path and move forward, but the user insists on stepping back several times. After several unsuccessful attempts to guide the user through temporary plots, the following scenario may be displayed: the player-controlled character collapse from staying in the maze too long and running out of supplies, resulting in a game over.

In the above embodiment, the interactive multimedia content can be terminated in a timely manner if the user successively deviates from the plot several times.

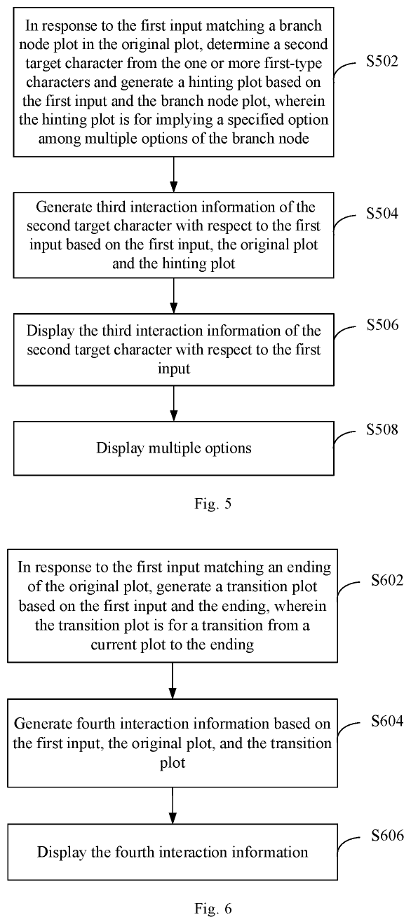

An embodiment of this disclosure can also suggest a correct option in advance through a scenario when the user is faced with a plurality of options, so that the interactive multimedia content can continue to progress without affecting the user's viewing experience. An interaction method provided by further embodiments of this disclosure will be described below with reference to FIG. 5.

FIG. 5 shows a flowchart of an interaction method according to further embodiments of the present disclosure. As shown in FIG. 5, the interaction method of this embodiment includes steps S502 to S508.

In step S502, in response to the first input matching a branch node plot in the original plot, a second target character is determined from the one or more first-type characters and a hinting plot is generated based on the first input and the branch node plot, wherein the hinting plot is for implying a specified option among multiple options of the branch node.

The branch node plot refers to a plot node that contains multiple options, with different options corresponding to different plot branches. The process of determining a second target character from the one or more first-type characters and generating the hinting plot may also be based on a machine learning model, for which reference can be made to the above embodiments.

The specified option can be used to advance the plot or to trigger the termination of the interactive multimedia content. For example, there may be two options, “climb a mountain” and “swim”, where the “climb a mountain” option may advance the narrative and the “swim” option will cause the game to fail. At this point, the hinting plot might be the sight of a giant crocodile in the water.

The second target character is the carrier of the hinting plot. When determining the second target character, character information of the first-type characters can be referenced, so that the second target character has a higher degree of match with the hinting plot. In some embodiments, the hinting plot can be determined first and then the second target character can be determined based on the hinting plot, or the second target character can be determined before the hinting plot is determined, or both the second target character and the hinting plot can be determined simultaneously.

In step S504, third interaction information of the second target character with respect to the first input is generated based on the first input, the original plot and the hinting plot.

The form of the third interaction information is similar to that of the first interaction information, but its function and specific content are different. In some embodiments, the third interaction information may also be generated by a machine learning model.

In step S506, the third interaction information of the second target character with respect to the first input is displayed. Thus, the second target character can be used to provide clues to a particular option to guide the user to further progress the plot.

In step S508, multiple options are displayed. The multiple options can be expressed through the spoken content of the second target character, or displayed as selection controls on the interface. The user can make a selection by triggering a selection control or by free input.

In the above embodiment, a hinting plot can be generated based on the user input and the original plot to suggest a specified option. In this way, the user can be guided to further progress the plot, while still being given a certain degree of freedom, thus improving the user experience.

In some embodiments of this disclosure, when the user input triggers an ending, a transition plot may be generated to avoid abrupt presentation of the ending content, thereby enabling more fluid and natural narrative progression. An interaction method provided by still other embodiments of the present disclosure will be described below with reference to FIG. 6.

FIG. 6 shows a flowchart of an interaction method according to still other embodiments of the present disclosure. As shown in FIG. 6, the interaction method of this embodiment includes steps S602 to S606.

In step S602, in response to the first input matching an ending of the original plot, a transition plot is generated based on the first input and the ending, wherein the transition plot is for a transition from a current plot to the ending.

The ending may be an ending of a particular chapter or an ending of the entire interactive multimedia content. Due to the predetermined content of the ending, even if the user's input matches the original plot, there may still be some differences from the original plot, so directly advancing according to the original plot would result in an incoherent storyline. For example, in the original plot, NPC 1 asked the user whether to stay on the boat or take a speedboat to land. In the original plot, staying on the boat would cause the game to fail, while taking a speedboat to land would trigger the ending. Not content with the two options offered, the user decided to swim ashore. In fact, regardless of the landing method, as long as the virtual character controlled by the user lands, the ending can be triggered so that the first input still matches the original plot. To make the plot more coherent, it is possible to display a user-controlled virtual character swimming and a scene of getting wet all over after landing, and then trigger the display of the ending.

If it is necessary for another virtual character to act as the carrier of the transition plot, a target character can also be determined from the first-type characters on the basis of the first input and ending as the carrier of the transition plot.

In some embodiments, a machine learning model can be utilized to process the first input and the ending to generate a transition plot.

In step S604, fourth interaction information is generated based on the first input, the original plot, and the transition plot.

The form of the fourth interaction information is similar to that of the first interaction information, but its function and specific content are different. In some embodiments, the fourth interaction information may also be generated by a machine learning model.

In step S606, the fourth interaction information is displayed.

For the way of displaying the fourth interaction information, reference can be made to the first interaction information, which will not be repeated here. At the end of the fourth interaction information, a screen corresponding to the ending can be displayed.

In the above embodiment, when the ending is triggered, a transition plot can be automatically generated based on the user input and the content of the ending, so that the displayed content can naturally transition from the user's current state to the ending, making the plot progression of the interactive multimedia content more fluid and reasonable, and thereby improving the user experience.

The above embodiments illustrate the automatic generation of various plots in the interactive multimedia content. In the embodiments of the present disclosure, in addition to the first-type characters, in some embodiments, second-type characters are also provided, which are not characters in the interactive multimedia content. For example, the second-type characters are not characters involved in the storyline in the interactive multimedia content, but background control characters used to schedule the interactive multimedia content. The processes of generating any of the temporary plots, hinting plots, or transition plots described above can be implemented by either the first-type characters or the second-type characters, i.e., by the processing logic or processing modules corresponding to that type. For example, in the case where each character corresponds to a machine learning agent model, implementation by a first-type character refers to implementation by an agent of the first-type character, and implementation by a second-type character refers to implementation by an agent of the second-type character. Implementation by an agent refers to inputting the information to be processed into the agent and obtaining the output of the agent as a result of processing.

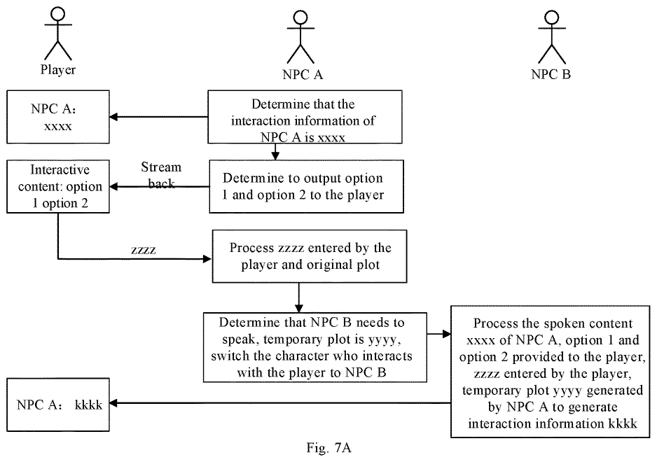

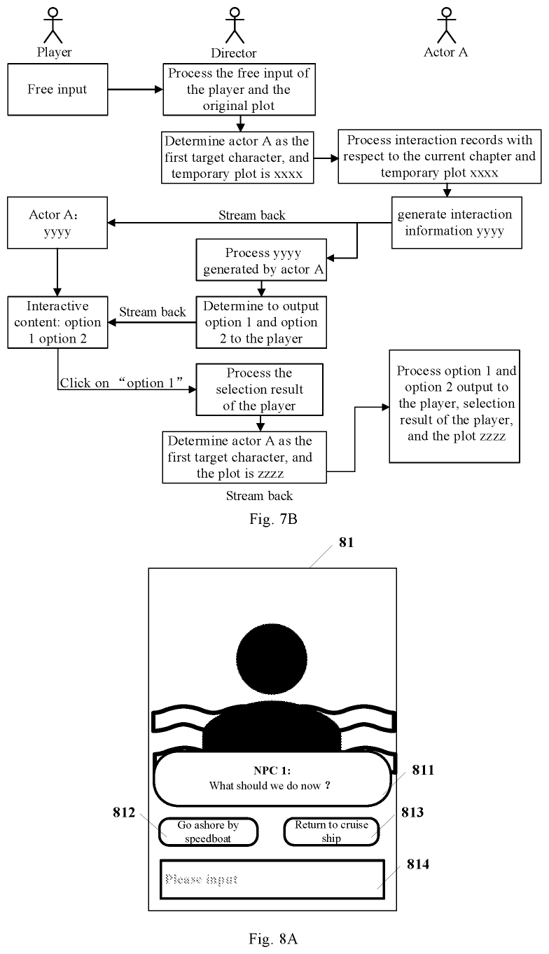

In some embodiments, in response to the mismatch between the first input and the original plot of the interactive multimedia content, a first target character is determined from the one or more first-type characters based on the first input and the original plot of the interactive multimedia content, and a temporary plot is generated through the first-type characters or a second type character. These two situations will be illustrated below with reference to FIGS. 7A and 7B, respectively.

In some embodiments, a first-type character is determined as the first target character to generate a temporary plot. For example, the last virtual character to speak among the first-type characters, that is, the last virtual character to interact with the user, is determined as the first target character to generate a temporary plot.

FIG. 7A shows a schematic diagram of interaction among a plurality of characters according to some embodiments of the present disclosure. As shown in FIG. 7A, in a certain chapter of the game, the game progress is driven by the interaction among the player, NPC A (a first type character), and NPC B (another first type character). A game engine is responsible for launching a corresponding AI agent, and passing the interaction content to the corresponding AI agent.

First, according to the plot of the game, NPC A speaks and outputs interaction information. For example, by using an AI agent corresponding to NPC A, the plot of the game such as the summary and ending of the current chapter and NPC A's memory summary are input into a machine learning model. The output obtained includes determined speech content of NPC A such as “xxx x”.

NPC A can also provide interaction content to the player in addition to outputting the speech content. Similarly, the AI agent corresponding to NPC A determines, based on the plot of the game, that options 1 and 2 should be provided to the player as the interaction content that can be streamed back to the player. Of course, if the determined content only requires input from the player with no options, a free input field can be provided to the user.

The speech content of NPC A and the interaction content provided to the player can be displayed on a corresponding user interface of NPC A.

Next, instead of selecting any option, the player enters “zzzz” as the first input. In response to the player's first input, the game engine can launch the AI agent corresponding to NPC A and transmit the player's first input to the AI agent corresponding to NPC A.

The AI agent corresponding to NPC A inputs “zzzz” entered by the player and the original plot into a machine learning model, obtains a temporary plot and a first target character NPC B, and then processes this information to output the temporary plot “yyyy” for the first input and the first target character, and should switch the character interacting with the player to NPC B as the first target virtual character. NPC B processes NPC A's speech content, options 1 and 2 provided to the player, “zzzz” input by the player, and the temporary plot “yyyy” generated by NPC A to generate interaction information “kkkk”, which can be streamed back to the player and displayed on the corresponding user interface of NPC A.

In some embodiments, the temporary plot is generated and the first target character is determined by a second-type character. FIG. 7B shows a schematic diagram of interaction among a plurality of characters according to other embodiments of the present disclosure. As shown in FIG. 7B, in a certain chapter of the game, the game progress is driven by the interaction among the player, a director (a second-type character), and actor A (a first-type character A). A game engine is responsible for launching a corresponding AI agent and transmitting interaction content to the corresponding AI agent. In FIG. 7B, during each round of interaction with a machine learning model, both the second-type character and the actor maintain historical dialogue records.

First, the player makes the first input, such as free input. The game engine launches an AI agent corresponding to the director and transmits the player's free input to the AI agent corresponding to the director.

The AI agent corresponding to the director inputs the plot of the game such as a summary and an ending of the current chapter, the interaction records with respect to the current chapter (including the last N chat records and the player's latest free input), and the summary of the previous chapter, into a machine learning model. The output obtained includes a determined first target character, i.e., actor A, and a temporary plot “xxxx”.

The game engine launches an AI agent corresponding to the first-type character A based on the above output, and transmits the interaction records with respect to the current chapter and the temporary plot determined by the director to the AI agent corresponding to actor A.

The AI agent corresponding to actor A inputs the interaction records with respect to the current chapter and the temporary plot into a machine learning model, and the output obtained includes first interaction information of actor A with respect to the freely input of the player, such as “yyyy”. The interaction information “yyyy” can be streamed back to the user and displayed on a user interface corresponding to the first-type character A.

The game engine further launches an AI agent corresponding to the director and transmits the interaction information output from the AI agent corresponding to actor A to the AI agent corresponding to the director.

The AI agent corresponding to the director determines to provide options 1 and 2 as interaction content to the player based on the plot of the game. The interaction content options 1 and 2 can be streamed back to the user. In response to the player's second input, such as a selection for option 1, the AI agent corresponding to the actor, similar to the process of determining the first target character, further inputs the player's selection result into a machine learning model, and the output obtained also includes a next determined target character and a plot.

The next target character determined may be the same as the first target character, such as actor A. At this point, actor A may continue to process the options 1 and 2 output to the player, as well as the player's selection result and a plot zzzz, to generate subsequent interaction information, which will not be elaborated here. Of course, the next target character determined may be different from the first target character, for example, actor B instead of actor A.

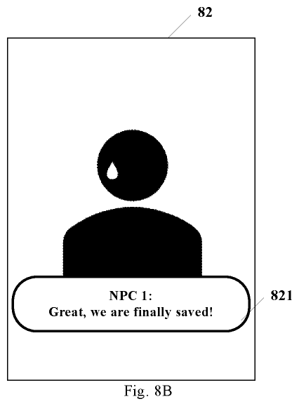

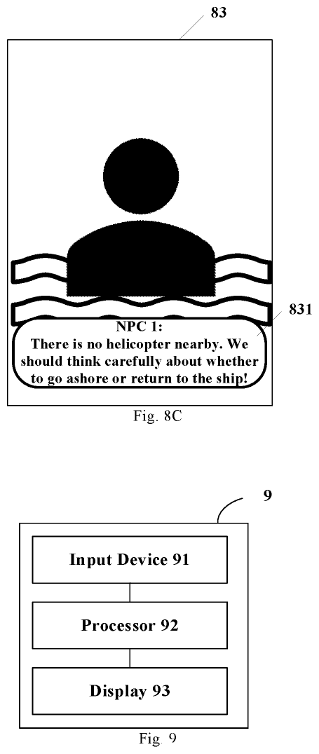

In some embodiments, an image of the first target character is displayed to enable clearer and more vivid communication of the interaction information. Schematic interface diagrams of interactive multimedia content that are generated in the above embodiments of the present application will be described below with reference to FIGS. 8A to 8C.

In an original plot, a user-controlled virtual character (the protagonist) and NPC 1 are aboard a cruise ship that is about to sink. The protagonist and NPC 1 fell into the water and the user had to decide whether to take a speedboat ashore or return to the cruise ship. If the user chooses to go ashore in a speedboat, the protagonist and NPC 1 will be rescued. In FIG. 8A, interface 81 shows NPC 1 in the water and dialogue box 811 of NPC 1 saying “What should we do now?” In addition, option 812 “Go ashore by speedboat” and option 813 “Return to cruise ship” are displayed on interface 81. In addition, interface 81 also displays input box 814 to allow the user to freely enter text.

If the user chooses “Go ashore by speedboat” in interface 81, the input matches the original plot. At this point, for example, the content shown in interface 82 in FIG. 8B is triggered. That is, after landing, the dialogue box 821 of NPC 1 displays “Great, we are finally saved!”, which is the content from the original plot.

If the user enters “Swim ashore” in input box 814 in interface 81, although it is not exactly the same as any other option, the input content matches the “Go ashore by speedboat” scenario, i.e., going ashore can save the user. Therefore, the content in interface 82 can still be triggered in this case.

If the user does not select any option, but instead enters “Wait for helicopter” into interface 81, then the user's input is not provided by the original plot, nor does it match any of the options in the original plot. At this point, a temporary plot needs to be generated based on the original plot and the user input as mentioned above. The display content corresponding to the temporary plot is, for example, as shown in interface 83 in FIG. 8C, where the dialogue box 831 of NPC 1 displays “There is no helicopter nearby. We should think carefully about whether to go ashore or return to the ship!” This content does not appear in the original plot. Alternatively, if it makes sense to have a helicopter based on the user input and the original plot, a scenario can be presented in which a helicopter picks up the user-controlled virtual character and NPC 1.

Below, embodiments of a related apparatus and device of this disclosure will be described with reference to FIGS. 9 to 12.

FIG. 9 shows a schematic structure diagram of an interaction apparatus according to some embodiments of the present disclosure. As shown in FIG. 9, the interaction apparatus 9 of this embodiment comprises: an input device 91 configured for receiving a first input from a user, the user controlling a virtual character in interactive multimedia content; one or more processors 92 configured for: determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot; and generating first interaction information of the first target character with respect to the first input based on the first input, the original plot, and the temporary plot; and a display 93 configured for displaying the first interaction information of the first target character with respect to the first input.

In some embodiments, the processor 92 may be configured to implement the interactive method described in any of the preceding embodiments of the present disclosure.

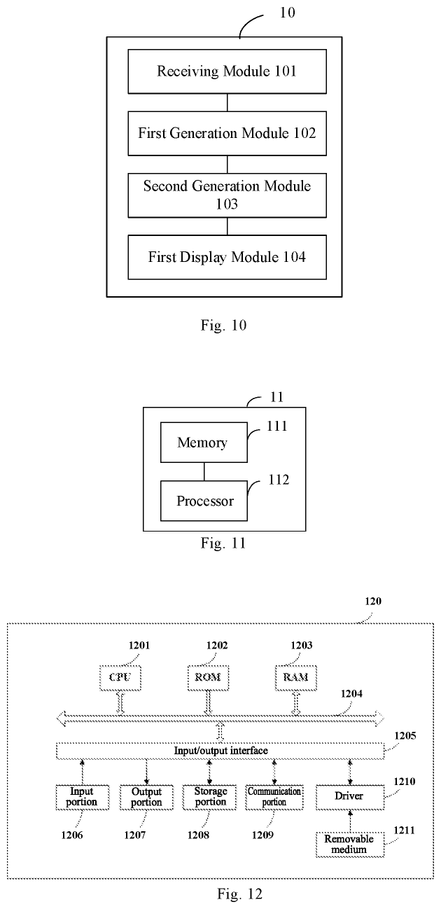

FIG. 10 shows a schematic structure diagram of an interaction apparatus according to other embodiments of the present disclosure. As shown in FIG. 10, the interaction apparatus 10 of this embodiment includes: a receiving module 101 configured for receiving a first input from a user, the user controlling a virtual character in interactive multimedia content; a first generation module 102 configured for determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot; a second generation module 103 configured for generating first interaction information of the first target character with respect to the first input based on the first input, the original plot, and the temporary plot; and a first display module 104 configured for displaying the first interaction information of the first target character with respect to the first input.

In some embodiments, the first generation module 102 is further configured for: processing, using a machine learning model, the first input, the original plot, and first prompt information, the first prompt information comprising an instruction to generate the temporary plot in response to the user input not matching the original plot; and obtaining a first target character and an interaction information generation instruction output from the machine learning model, wherein the interaction information generation instruction comprises the temporary plot in response to the first input not matching the original plot.

In some embodiments, the first prompt information further comprises character information of the one or more first-type characters, and an instruction to select the first target character based on the character information.

In some embodiments, the second generation module 103 is further configured for: processing the first input, the original plot, the temporary plot and second prompt information using a machine learning model, wherein the second prompt information comprises character information and memory summary of the first target character; and obtaining first interaction information of the first target character with respect to the first input, the first interaction information being output from the machine learning model.

In some embodiments, the interaction apparatus further comprises a second display module configured for: generating, in response to a predetermined number of successive inputs of the user not matching the original plot, an instruction to terminate the interactive multimedia content based on the first input and the original plot of the interactive multimedia content; generating second interaction information based on the first input, the original plot and the instruction to terminate the interactive multimedia content, the second interaction information representing the termination of the interactive multimedia content; and displaying the second interaction information.

In some embodiments, the interaction apparatus further includes a third display module configured for: determining, in response to the first input matching a branch node plot in the original plot, a second target character from the one or more first-type characters based on the first input and the branch node plot, and generating a hinting plot for implying a specified option among multiple options of the branch node; generating third interaction information of the second target character with respect to the first input based on the first input, the original plot and the hinting plot; displaying the third interaction information of the second target character with respect to the first input; and displaying the multiple options.

In some embodiments, the interaction apparatus further includes a fourth display module configured for: generating, in response to the first input matching an ending of the original plot, a transition plot based on the first input and the ending, wherein the transition plot is for a transition from a current plot to the ending; generating fourth interaction information based on the first input, the original plot, and the transition plot; and displaying the fourth interaction information.

In some embodiments, the first generation module 102 is further configured for determining, in response to the mismatch between the first input and the original plot of the interactive multimedia content, a first target character from the one or more first-type characters based on the first input and the original plot of the interactive multimedia content and generating the temporary plot through the first-type characters or a second type character, wherein the second-type character is not a character in the interactive multimedia content.

In some embodiments, the interactive multimedia content comprises a plurality of chapters, and the original plot corresponds to one of the plurality of chapters of the interactive multimedia content.

In some embodiments, the first input is a natural language text or a result of selecting from a plurality of options; and the first interaction information comprises a dialogue text or a plurality of options.

In some embodiments, the interaction apparatus further includes a fifth display module configured for displaying an image of the first target character.

In some embodiments, the character information includes at least one of a character setting, a dialogue style, or a behavioral guideline.

It should be noted that the above units are only logical modules divided according to their specific functions and are not intended to limit the specific ways in which they are implemented. For example, they may be implemented in software, hardware or a combination of software and hardware. In practical implementation, the above units may be implemented as independent physical entities, or they can also be implemented by a single entity (such as a processor (CPU or DSP), integrated circuit, etc.). In addition, the above units are indicated by dashed lines in the accompanying drawings, indicating that these units may not actually exist and that the operations/functions they perform may be performed by a processing circuit per se.

In addition, although not shown, the device may also include a memory that can store various information generated by the device or various units in the device during operation, programs and data used for operation, data to be sent by a communication unit, and so on. The memory may be volatile memory and/or non-volatile memory. For example, the memory may include, but is not limited to, random access memory (RAM), dynamic random access memory (DRAM), static random access memory (SRAM), read-only memory (ROM), and flash memory. Of course, the memory may also be located outside of the device. Optionally, although not shown, the device may also include a communication unit that may be used to communicate with other apparatus. In an example, the communication unit may be implemented in any suitable manner known in the art, including communication components such as an antenna array and/or radio frequency links, various types of interfaces, communication units, and so on, which will not be described in detail herein. In addition, the device may also include other components not shown, such as a RF link, a baseband processing unit, a network interface, a processor, a controller, etc., which will not be described in detail herein.

Some embodiments of the present disclosure further provide an electronic device. FIG. 11 shows a block diagram of an electronic device according to some embodiments of the present disclosure. For example, in some embodiments, the electronic device 8 may be any type of electronic device, such as, but not limited to, a mobile terminal such as a mobile phone, a laptop, a digital broadcast receiver, a PDA (personal digital assistant), a PAD (tablet computer), a PMP (portable multimedia player), a vehicle terminal (such as vehicle navigation terminal), or a fixed terminal such as a digital TV, a desktop computer, etc. For example, the electronic device 11 may include a display panel for displaying data and/or execution results utilized in the scheme of the present disclosure. For example, the display panel can have various shapes. For example, it can be a rectangular panel, an elliptical panel, or a polygonal panel. Furthermore, the display can be not only flat, but curved or even spherical.

As shown in FIG. 11, the electronic device 11 of this embodiment comprises: a memory 111 and a processor 112 coupled to the memory 111. It should be noted that the components of the electronic device 11 shown in FIG. 11 are illustrative and not limiting. Depending on the actual application requirements, the electronic device 11 may include other components. The processor 112 can control other components in the electronic device 11 to perform desired functions.

In some embodiments, the memory 111 is used to store one or more computer-readable instructions. The processor 112 is used to execute these computer-readable instructions that, when executed by the processor 112, perform the method according to any of the above embodiments. The specific implementation of each step of the method and related explanations can be found in the above embodiments, and will not be repeated here.

For example, the processor 112 and the memory 111 can directly or indirectly communicate with each other. For example, the processor 112 and the memory 111 can communicate over a network. The network can be a wireless network, a wired network, and/or any combination of wireless and wired networks. The processor 112 and the memory 111 may also communicate with each other over a system bus, and this disclosure is not limited thereto.

For example, the processor 112 may be embodied as various suitable processors, processing devices, etc., such as a central processing unit (CPU), a graphics processing unit (GPU), a network processor (NP), etc; It can also be a digital signal processor (DSP), an application specific integrated circuit (ASIC), a field programmable gate array (FPGA), or other programmable logic devices, discrete gates or transistor logic devices, or discrete hardware components. The central processing unit (CPU) may be based on the X86 or ARM architecture. For example, the memory 111 may include any combination of various forms of computer-readable storage media, such as volatile memory and/or non-volatile memory. The memory 111 may include a system memory, which stores an operating system, application programs, a boot loader, a database, and other programs. Various applications and data can also be stored in the storage media.

In addition, according to some embodiments of the present disclosure, various operations/processes according to the present disclosure may be implemented by software and/or firmware, and programs constituting the software may be installed, from storage media or networks, on a computer system having dedicated hardware structures, such as the computer system 12 shown in FIG. 12. The computer system with various programs installed can perform various functions, including those functions mentioned above. FIG. 12 shows a schematic structure diagram of a computer system that can be adopted according to some embodiments of the present disclosure.

In FIG. 12, the central processing unit (CPU) 1201 performs various processes based on programs stored in the read-only memory (ROM) 1202 or programs loaded from the storage device 1208 to the random access memory (RAM) 1203. Data required for CPU 1201 to perform various processes is also stored in RAM 1203 as needed. The central processing unit is only an example and can also be other types of processors, such as the various processors mentioned above. The ROM 1202, RAM 1203, and storage section 1208 may be various forms of computer readable storage media, as described below. It should be noted that although ROM 1202, RAM 1203, and storage device 1208 are shown separately in FIG. 12, one or more of them may be combined or located in the same or different memory or storage modules.

The CPU 1201, the ROM 1202, and the RAM 1203 are connected to each other via a bus 1204. An input/output (I/O) interface 1205 is also connected to the bus 1204.

The following components are connected to the input/output interface 1205: an input section 1206, such as a touch screen, a touch pad, a keyboard, a mouse, an image sensor, a microphone, an accelerometer, a gyroscope, etc; an output section 1207, including a display such as a cathode ray tube (CRT), liquid crystal display (LCD), a speaker, a vibrator, etc; a storage section 1208, including a hard disk drive, a magnetic tape drive, etc; and a communication section 1209 including a network interface card such as a LAN card, a modem, etc. The communication section 1209 allows communication to be performed over a network, such as the Internet. It is easy to understand that although the various means or modules in the electronic device 1200 are shown in FIG. 12 communicating over the bus 1204, they may also communicate over networks or other means, where the networks may include wireless networks, wired networks, and/or any combination of wireless and wired networks.

A drive 1210 is also connected to input/output interface 1205 as needed. A removable medium 1211, such as a magnetic disk, an optical disk, a magneto-optical disk, a semiconductor memory, etc., is mounted on the drive 1210 as needed so that computer programs read from the medium can be installed in the storage section 1208 as needed.

In the case of implementing the above series of processes by software, the programs that make up the software may be installed from a network, such as the Internet, or from a storage medium, such as the removable media 1211.

According to an embodiment of the present disclosure, the processes described above with reference to the flowchart can be implemented as a computer software program. For example, some embodiments of the present disclosure include a computer program product comprising a computer program carried on a computer-readable medium, the computer program containing program code for performing the method illustrated in the flowcharts. In such an embodiment, the computer program may be downloaded and installed from the network through the communication device 1209, or installed from the storage device 1208, or from the ROM 1202. When the computer program is executed by a CPU 1201, the above functions defined in the method provided by the embodiment of the present disclosure are performed.

It should be noted that, in the context of the present disclosure, a computer-readable medium may be a tangible medium, which may contain or store a program for use by or in connection with an instruction execution system, apparatus, or device. The computer readable medium may be a computer readable signal medium or a computer readable storage medium, or any combination of thereof. The computer readable storage medium may be, but is not limited to: an electronic, magnetic, optical, electromagnetic, infrared, or semiconductor system, apparatus, or device, or any combination of the above. More specific examples of the computer readable storage medium may include, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may include a data signal that is propagated in the baseband or as part of a carrier, carrying computer readable program code. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, including but not limited to wire, fiber optic cable, RF (radio frequency), etc., or any suitable combination of the foregoing.

The above computer readable medium may be included in the electronic device described above; or it may exist alone without being assembled into the electronic device.

In some embodiments, there is further provided a computer program, comprising: instructions that, when executed by a processor, cause the processor to perform the method of any one of the above embodiments. For example, the instructions can be embodied as computer program code.

In embodiments of the present disclosure, computer program code for executing operations of the present disclosure may be complied by any combination of one or more program design languages, the program design languages including, but not limited to, object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area networks (LAN) or wide area networks (WAN), or connected to external computers (for example using an Internet service provider via the Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules, components or units involved in the embodiments described in the present disclosure can be implemented by software or hardware. Wherein, the names of the modules, components or units do not constitute a limitation on the modules, components or units themselves under certain circumstances.

The functions described above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD), etc.

The above description only shows some embodiments of the present disclosure and illustrates technical principles applied in the present disclosure. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

Many specific details are elaborated in the description of the present disclosure. However, it is understood that embodiments of the present invention can be implemented without these specific details. In other cases, well-known methods, structures, and techniques are not described in detail so as not to obscure the understanding of the description.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. An interaction method, comprising:
receiving a first input from a user, the user controlling a virtual character in interactive multimedia content;
determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot;
generating first interaction information of the first target character with respect to the first input based on the first input, the original plot, and the temporary plot; and
displaying the first interaction information of the first target character with respect to the first input.

2. The interaction method according to claim 1, wherein the determining, in response to the mismatch between the first input and the original plot of the interactive multimedia content, the first target character from the one or more first-type characters based on the first input and the original plot of the interactive multimedia content, and generating the temporary plot comprises:
processing, using a machine learning model, the first input, the original plot, and first prompt information, the first prompt information comprising an instruction to generate the temporary plot in response to the user input not matching the original plot; and
obtaining a first target character and an interaction information generation instruction output from the machine learning model, wherein the interaction information generation instruction comprises the temporary plot in response to the first input not matching the original plot.

3. The interaction method according to claim 2, wherein the first prompt information further comprises character information of the one or more first-type characters, and an instruction to select the first target character based on the character information.

4. The interaction method according to claim 1, wherein the generating the first interaction information of the first target character with respect to the first input based on the first input, the original plot, and the temporary plot comprises:
processing the first input, the original plot, the temporary plot and second prompt information using a machine learning model, wherein the second prompt information comprises character information and memory summary of the first target character; and
obtaining first interaction information of the first target character with respect to the first input, the first interaction information being output from the machine learning model.

5. The interaction method according to claim 1, further comprising:
generating, in response to a predetermined number of successive inputs of the user not matching the original plot, an instruction to terminate the interactive multimedia content based on the first input and the original plot of the interactive multimedia content;
generating second interaction information based on the first input, the original plot and the instruction to terminate the interactive multimedia content, the second interaction information representing the termination of the interactive multimedia content; and
displaying the second interaction information.

6. The interaction method according to claim 1, further comprising:
determining, in response to the first input matching a branch node plot in the original plot, a second target character from the one or more first-type characters based on the first input and the branch node plot, and generating a hinting plot for implying a specified option among multiple options of the branch node;
generating third interaction information of the second target character with respect to the first input based on the first input, the original plot and the hinting plot;
displaying the third interaction information of the second target character with respect to the first input; and
displaying the multiple options.

7. The interaction method according to claim 1, further comprising:
generating, in response to the first input matching an ending of the original plot, a transition plot based on the first input and the ending, wherein the transition plot is for a transition from a current plot to the ending;
generating fourth interaction information based on the first input, the original plot, and the transition plot; and
displaying the fourth interaction information.

8. The interaction method according to claim 1, wherein the determining, in response to the mismatch between the first input and the original plot of the interactive multimedia content, the first target character from the one or more first-type characters based on the first input and the original plot of the interactive multimedia content, and generating the temporary plot comprises:
in response to the mismatch between the first input and the original plot of the interactive multimedia content, determining a first target character from the one or more first-type characters based on the first input and the original plot of the interactive multimedia content and generating the temporary plot through the first-type characters or a second type character, wherein the second-type character is not a character in the interactive multimedia content.

9. The interaction method according to claim 1, wherein the interactive multimedia content comprises a plurality of chapters, and the original plot corresponds to one of the plurality of chapters of the interactive multimedia content.

10. The interaction method according to claim 1, wherein:
the first input is a natural language text or a result of selecting from a plurality of options; and
the first interaction information comprises a dialogue text or a plurality of options.

11. The interaction method according to claim 1, further comprising:
displaying an image of the first target character.

12. The interaction method according to claim 3, wherein the character information comprises at least one of a character setting, a dialogue style, or a behavioral guideline.

13-14. (canceled)

15. An interaction apparatus, comprising:
at least one memory; and
at least one processor coupled to the memory, the processor configured to, based on instructions stored in the memory, carry out an interaction method comprising:
receiving a first input from a user, the user controlling a virtual character in interactive multimedia content;
determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot;
generating first interaction information of the first target character with respect to the first input based on the first input, the original plot, and the temporary plot; and
displaying the first interaction information of the first target character with respect to the first input.

16. A non-transitory computer-readable storage medium stored thereon a computer program that, when executed by a processor, implements an interaction method comprising:
receiving a first input from a user, the user controlling a virtual character in interactive multimedia content;
determining, in response to a mismatch between the first input and an original plot of the interactive multimedia content, a first target character from one or more first-type characters based on the first input and the original plot of the interactive multimedia content, and generating a temporary plot, wherein the first-type characters are non-user controlled virtual characters in the interactive multimedia content, and the temporary plot is for guiding the user to provide a second input to trigger the original plot;
generating first interaction information of the first target character with respect to the first input based on the first input, the original plot, and the temporary plot; and
displaying the first interaction information of the first target character with respect to the first input.

17-18. (canceled)

19. The interaction apparatus according to claim 15, wherein the determining, in response to the mismatch between the first input and the original plot of the interactive multimedia content, the first target character from the one or more first-type characters based on the first input and the original plot of the interactive multimedia content, and generating the temporary plot comprises:
processing, using a machine learning model, the first input, the original plot, and first prompt information, the first prompt information comprising an instruction to generate the temporary plot in response to the user input not matching the original plot; and
obtaining a first target character and an interaction information generation instruction output from the machine learning model, wherein the interaction information generation instruction comprises the temporary plot in response to the first input not matching the original plot.

20. The interaction apparatus according to claim 19, wherein the first prompt information further comprises character information of the one or more first-type characters, and an instruction to select the first target character based on the character information.

21. The interaction apparatus according to claim 15, wherein the generating the first interaction information of the first target character with respect to the first input based on the first input, the original plot, and the temporary plot comprises:
processing the first input, the original plot, the temporary plot and second prompt information using a machine learning model, wherein the second prompt information comprises character information and memory summary of the first target character; and
obtaining first interaction information of the first target character with respect to the first input, the first interaction information being output from the machine learning model.

22. The interaction apparatus according to claim 15, wherein the processor is further configured for:
generating, in response to a predetermined number of successive inputs of the user not matching the original plot, an instruction to terminate the interactive multimedia content based on the first input and the original plot of the interactive multimedia content;
generating second interaction information based on the first input, the original plot and the instruction to terminate the interactive multimedia content, the second interaction information representing the termination of the interactive multimedia content; and
displaying the second interaction information.

23. The interaction apparatus according to claim 15, wherein the processor is further configured for:
determining, in response to the first input matching a branch node plot in the original plot, a second target character from the one or more first-type characters based on the first input and the branch node plot, and generating a hinting plot for implying a specified option among multiple options of the branch node;
generating third interaction information of the second target character with respect to the first input based on the first input, the original plot and the hinting plot;
displaying the third interaction information of the second target character with respect to the first input; and
displaying the multiple options.

24. The interaction apparatus according to claim 15, wherein the processor is further configured for:
generating, in response to the first input matching an ending of the original plot, a transition plot based on the first input and the ending, wherein the transition plot is for a transition from a current plot to the ending;
generating fourth interaction information based on the first input, the original plot, and the transition plot; and
displaying the fourth interaction information.
